(19) United States
(12) Patent Application Publication
(10) Pub. No.: US 2020/0298874 A1
(43) Pub. Date: Sep. 24, 2020

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Junpei Noguchi, Wako-shi (JP); Yasushi Shoda, Wako-shi (JP); Yuki Hara, Wako-shi (JP); Ryoma Taguchi, Tokyo (JP); Yuta Takada, Tokyo (JP)

(21) Appl. No.: 16/809,597

(22) Filed: Mar. 5, 2020

(30) Foreign Application Priority Data
Mar. 19, 2019 (JP) 2019-051584

(51) Int. Cl. B60W 50/10; B60W 10/04; B60W 10/20; B60W 30/06; B60W 60/00

(52) U.S. Cl. CPC B60W 50/10; B60W 10/04; B60W 10/20; B60W 30/06; B60W 2540/041; B60W 2720/10; B60W 2720/12; B60W 2710/20; B60W 60/00253

(57) ABSTRACT

A vehicle control system includes a recognizer configured to recognize a surrounding environment of a vehicle and a driving controller configured to automatically perform speed control and steering control of the vehicle on the basis of a recognition result of the recognizer, wherein the driving controller is configured to cause, after letting a user alight the vehicle, the vehicle to start traveling from a stopped state when the recognizer has recognized a specific operation that the alighted user performs on or toward a body of the vehicle.

### CROSS-REFERENCE TO RELATED APPLICATION

Priority is claimed on Japanese Patent Application No. 2019-051584, filed Mar. 19, 2019, the content of which is incorporated herein by reference.

### BACKGROUND

### Field of the Invention

The present invention relates to a vehicle control system, a vehicle control method, and a storage medium.

### Description of Related Art

Research on automatic control of vehicles has advanced in recent years. In this regard, a technique of notifying a rider's terminal device of the position of a vehicle that has been parked by automated driving is known (for example, Japanese Unexamined Patent Application, First Publication No. 2017-182263).

### SUMMARY

However, in the related art, when a vehicle is parked by automated driving, a rider may be required to operate a terminal device or to operate a certain operation device to instruct parking. These operations may be cumbersome and inconvenient.

Embodiments of the present invention have been made in view of such circumstances and it is an object of the present invention to provide a vehicle control system, a vehicle control method, and a storage medium that can improve convenience. A vehicle control system, a vehicle control method, and a storage medium according to the present invention employ the following configurations.

(1) A vehicle control system according to an aspect of the present invention includes a recognizer configured to recognize a surrounding environment of a vehicle, and a driving controller configured to automatically perform speed control and steering control of the vehicle on the basis of a recognition result of the recognizer, wherein the driving controller is configured to cause, after letting a user alight the vehicle, the vehicle to start traveling from a stopped state when the recognizer has recognized a specific operation that the alighted user performs on or toward a body of the vehicle.

(2) In the above aspect (1), the specific operation includes a gesture of the alighted user.

(3) In the above aspect (1), the specific operation includes knocking on the body of the vehicle.

(4) In the above aspect (3), the driving controller is configured to cause the vehicle to start traveling from a stopped state when the recognizer has recognized that the knocking has a predetermined rhythm or that the knocking includes a predetermined number of knocks.

(5) In the above aspect (3), the recognizer is configured to recognize the knocking detected by a sound detector configured to detect a sound in a passenger compartment of the vehicle.

(6) In the above aspect (1), the specific operation includes a stroking operation of the alighted user.

(7) In the above aspect (6), the recognizer is configured to recognize the stroking operation detected by a contact detector configured to detect touching of a person on the body of the vehicle.

(8) A vehicle control method according to an aspect of the present invention includes a computer recognizing a surrounding environment of a vehicle, automatically performing speed control and steering control of the vehicle on the basis of a result of the recognition, and causing, after letting a user alight the vehicle, the vehicle to start traveling from a stopped state upon recognizing a specific operation that the alighted user performs on or toward a body of the vehicle.

(9) A non-transitory computer-readable storage medium according to an aspect of the present invention stores a program that causes a computer to recognize a surrounding environment of a vehicle, automatically perform speed control and steering control of the vehicle on the basis of a result of the recognition, and cause, after letting a user alight the vehicle, the vehicle to start traveling from a stopped state upon recognizing a specific operation that the alighted user performs on or toward a body of the vehicle.

According to the above aspects (1) to (9), convenience can be improved.

According to the above aspects (2) to (7), the vehicle can be easily parked in the parking lot by automated driving.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram schematically showing a scene in which a self-propelled parking event is performed.

FIG. 4 is a diagram showing an example of the configuration of a parking lot management device.

FIG. 5 is a diagram showing an example of an execution screen of an application for generating specific gesture information.

FIG. 6 is a diagram showing an example of a scene in which a self-propelled parking event relating to vehicle storage is started by a gesture.

FIG. 7 is a diagram showing an example of a scene in which a self-propelled parking event relating to vehicle storage is started by knocking.

FIG. 8 is a diagram showing an example of a scene in which a self-propelled parking event relating to vehicle storage is started by a stroking operation.

FIG. 9 is a diagram showing an example of an image of a passenger compartment captured by a vehicle interior camera and an image of a passenger compartment captured in the past.

FIG. 10 is a flowchart showing a flow of a series of processes for starting a self-propelled parking event relating to vehicle storage.

FIG. 11 is a flowchart showing a flow of a series of processes for stopping a self-propelled parking event relating to vehicle storage.

FIG. 12 is a diagram showing an example of the hardware configuration of an automated driving control device according to an embodiment.

### DETAILED DESCRIPTION OF THE INVENTION

Hereinafter, embodiments of a vehicle control device, a vehicle control method, and a storage medium of the present invention will be described with reference to the drawings. The following description will refer to the case in which left-hand traffic laws are applied, but the terms “left” and “right” simply need to be reversed when right-hand traffic laws are applied.

### [Overall Configuration]

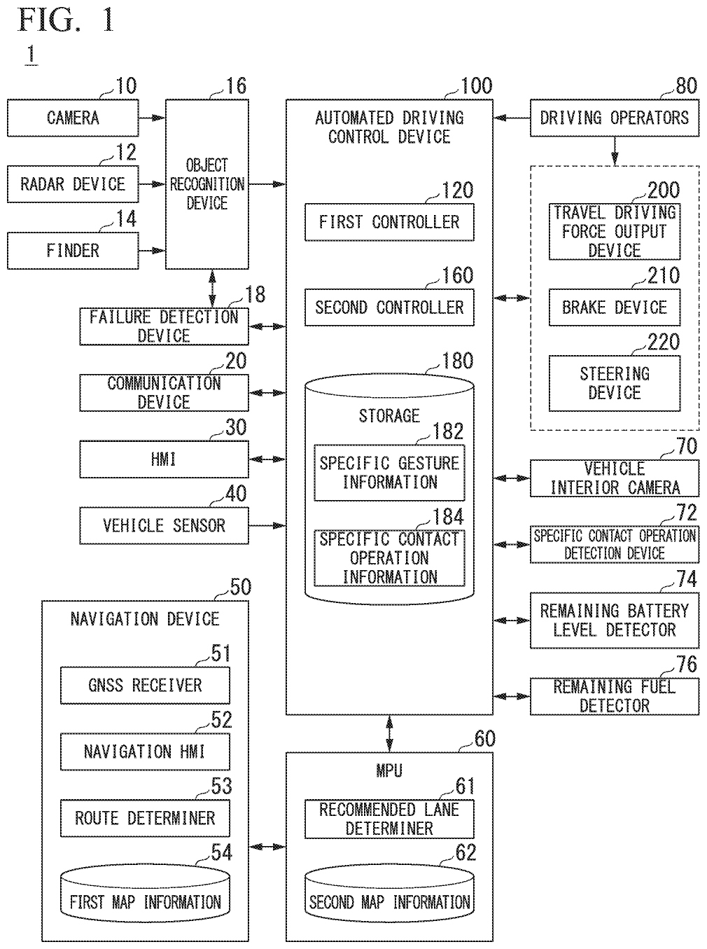

FIG. 1 is a configuration diagram of a vehicle system 1 using a vehicle control device according to an embodiment. A vehicle in which the vehicle system 1 is mounted is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. The electric motor operates using electric power generated by a generator connected to the internal combustion engine or using discharge power of a secondary battery or a fuel cell. The following description will refer to the case where the driving source of the vehicle M is a combination of the internal combustion engine and the electric motor.

The vehicle system 1 includes, for example, a camera 10, a radar device 12, a finder 14, an object recognition device 16, a failure detection device 18, a communication device 20, a human machine interface (HMI) 30, vehicle sensors 40, a navigation device 50, a map positioning unit (MPU) 60, a vehicle interior camera 70, a specific contact operation detection device 72, a remaining battery level detector 74, a remaining fuel detector 76, driving operators 80, an automated driving control device 100, a travel driving force output device 200, a brake device 210, and a steering device 220.

These devices or apparatuses are connected to each other by a multiplex communication line or a serial communication line such as a controller area network (CAN) communication line, a wireless communication network, or the like. The components shown in FIG. 1 are merely an example and some of the components may be omitted or other components may be added.

The camera 10 is, for example, a digital camera using a solid-state imaging device such as a charge coupled device (CCD) or a complementary metal oxide semiconductor (CMOS). The camera 10 is attached to the vehicle in which the vehicle system 1 is mounted (hereinafter referred to as an own vehicle M) at an arbitrary location. For example, the camera 10 repeats imaging of the surroundings of the own vehicle M at regular intervals. The camera 10 may also be a stereo camera.

The radar device 12 radiates radio waves such as millimeter waves around the own vehicle M and detects radio waves reflected by an object (reflected waves) to detect at least the position (distance and orientation) of the object. The radar device 12 is attached to the own vehicle M at an arbitrary location. The radar device 12 may detect the position and velocity of an object using a frequency modulated continuous wave (FM-CW) method.

The finder 14 is a light detection and ranging (LIDAR) finder. The finder 14 illuminates the surroundings of the own vehicle M with light and measures scattered light. The finder 14 detects the distance to a target on the basis of a period of time from when light is emitted to when light is received. The light radiated is, for example, pulsed laser light. The finder 14 is attached to the own vehicle M at an arbitrary location.

The object recognition device 16 performs a sensor fusion process on results of detection by some or all of the camera 10, the radar device 12, and the finder 14 to recognize the position, type, speed, or the like of the object. The object recognition device 16 outputs the recognition result to the automated driving control device 100. The object recognition device 16 may output detection results of the camera 10, the radar device 12 and the finder 14 to the automated driving control device 100 as they are. The object recognition device 16 may be omitted from the vehicle system 1.

The failure detection device 18 detects failures of components for detecting the surroundings of the own vehicle M (for example, the camera 10, the radar device 12, the finder 14, and the object recognition device 16) among components included in the vehicle system 1. Hereinafter, when failures of the components for detecting the surroundings of the own vehicle M (for example, the camera 10, the radar device 12, the finder 14, and the object recognition device 16) are not distinguished from each other, each component will be referred to as a “detection device.” The failure detection device 18 determines that the detection device has failed, for example, when the output of a detection result of the detection device is interrupted, when a detection result of the detection device indicates an abnormal value, or when the detection device has stopped operating. The failure detection device 18 determines that the detection device has failed, for example, when the detection device has partly or wholly failed. The failure detection device 18 is an example of a “failure detector.”

For example, the communication device 20 communicates with other vehicles or a parking lot management device (which will be described later) present near the own vehicle M or communicates with various server devices using a cellular network, a Wi-Fi network, Bluetooth (registered trademark), dedicated short range communication (DSRC) or the like.

The HMI 30 presents various types of information to a rider in the own vehicle M and receives an input operation from the rider. The HMI 30 includes various display devices, a speaker, a buzzer, a touch panel, switches, keys, and the like.

The vehicle sensors 40 include a vehicle speed sensor that detects the speed of the own vehicle M, an acceleration sensor that detects the acceleration thereof, a yaw rate sensor that detects an angular speed thereof about the vertical axis, an orientation sensor that detects the orientation of the own vehicle M, or the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the own vehicle M on the basis of signals received from GNSS satellites. The position of the own vehicle M may also be identified or supplemented by an inertial navigation system (INS) using the output of the vehicle sensors 40. The navigation HMI 52 includes a display device, a speaker, a touch panel, a key, or the like. The navigation HMI 52 may be partly or wholly shared with the HMI 30 described above. For example, the route determiner 53 determines a route from the position of the own vehicle M identified by the GNSS receiver 51 (or an arbitrary input position) to a destination input by the rider (hereinafter referred to as an on-map route) using the navigation HMI 52 by referring to the first map information 54. The first map information 54 is, for example, information representing shapes of roads by links indicating roads and nodes connected by the links. The first map information 54 may include curvatures of roads, point of interest (POI) information, or the like. The on-map route is output to the MPU 60. The navigation device 50 may also perform route guidance using the navigation HMI 52 on the basis of the on-map route. The navigation device 50 may be realized, for example, by a function of a terminal device such as a smartphone or a tablet possessed by the rider (hereinafter referred to as a terminal device TM). The navigation device 50 may also transmit the current position and the destination to a navigation server via the communication device 20 and acquire a route equivalent to the on-map route from the navigation server.

The MPU 60 includes, for example, a recommended lane determiner 61 and holds second map information 62 in a storage device such as an HDD or a flash memory. The recommended lane determiner 61 divides the on-map route provided from the navigation device 50 into a plurality of blocks (for example, into blocks each 100 meters long in the direction in which the vehicle travels) and determines a recommended lane for each block by referring to the second map information 62. The recommended lane determiner 61 determines the number of the lane from the left in which to travel. When there is a branch point on the on-map route, the recommended lane determiner 61 determines a recommended lane such that the own vehicle M can travel on a reasonable route for proceeding to the branch destination.

The second map information 62 is map information with higher accuracy than the first map information 54. The second map information 62 includes, for example, information of the centers of lanes or information of the boundaries of lanes. The second map information 62 may also include road information, traffic regulation information, address information (addresses/postal codes), facility information, telephone number information, or the like. The second map information 62 may be updated as needed by the communication device 20 communicating with another device.

The vehicle interior camera 70 is, for example, a digital camera using a solid-state imaging device such as a CCD or a CMOS. The vehicle interior camera 70 is a camera for imaging objects placed in the passenger compartment. The vehicle interior camera 70 is attached to, for example, arbitrary locations where it can image states of the passenger compartment of the own vehicle M. The vehicle interior camera 70 images the passenger compartment of the own vehicle, for example, at predetermined timings or periodically and repeatedly. The vehicle interior camera 70 may be a stereo camera.

The specific contact operation detection device 72 includes, for example, a sound detector that detects a knocking sound of the own vehicle M and a contact detector that detects an operation of stroking the own vehicle M. The sound detector is realized, for example, by a microphone installed in the passenger compartment and the contact detector is realized, for example, by a touch panel installed on the surface of the body of the own vehicle M.

The remaining battery level detector 74 detects a remaining level (for example, state of charge (SoC)) of a secondary storage battery that supplies power to the electric motor that is a driving source included in the own vehicle M.

The remaining fuel detector 76 detects a remaining amount of fuel (gasoline) used for combustion of the internal combustion engine of the own vehicle M or a remaining amount of fuel (for example, hydrogen, hydrocarbon, or alcohol) used for power generation of the fuel cell. Hereinafter, when the secondary storage battery and the fuel cell are not distinguished from each other, each will be referred to as a battery.

The driving operators 80 include, for example, an accelerator pedal, a brake pedal, a shift lever, a steering wheel, a different shaped steering member, a joystick, and other operators. Sensors for detecting the amounts of operation or the presence or absence of operation are attached to the driving operators 80. Results of the detection are output to the automated driving control device 100 or some or all of the travel driving force output device 200, the brake device 210, and the steering device 220.

The automated driving control device 100 includes, for example, a first controller 120, a second controller 160, and a storage 180. Each of the first controller 120 and the second controller 160 is realized, for example, by a hardware processor such as a central processing unit (CPU) executing a program (software). Some or all of these components may be realized by hardware (including circuitry) such as large scale integration (LSI), an application specific integrated circuit (ASIC), a field-programmable gate array (FPGA), or a graphics processing unit (GPU) or may be realized by hardware and software in cooperation. The program may be stored in advance in a storage device (a storage device having a non-transitory storage medium) such as an HDD or a flash memory of the automated driving control device 100 or may be stored in a detachable storage medium such as a DVD or a CD-ROM and then installed in the HDD or flash memory of the automated driving control device 100 by mounting the storage medium (the non-transitory storage medium) in a drive device. The storage 180 stores specific gesture information 182 and specific contact operation information 184. Details of the specific gesture information 182 and the specific contact operation information 184 will be described later.

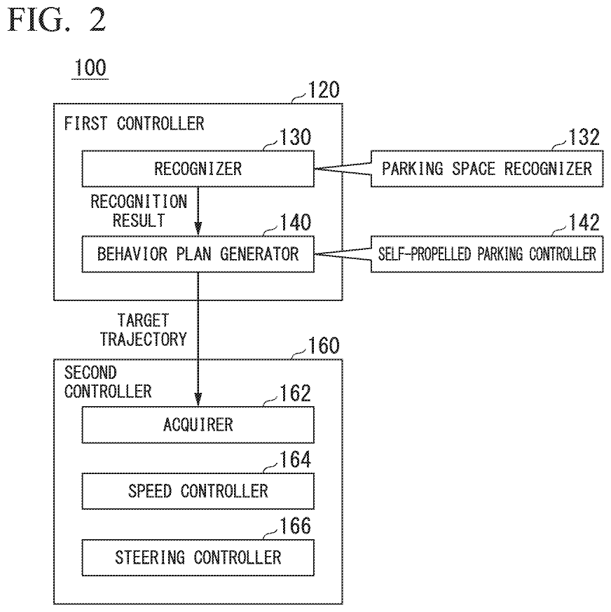

FIG. 2 is a functional configuration diagram of the first controller 120 and the second controller 160. The first controller 120 includes, for example, a recognizer 130 and a behavior plan generator 140. For example, the first controller 120 realizes a function based on artificial intelligence (AI) and a function based on a previously given model in parallel. For example, the function of “recognizing an intersection” is realized by performing recognition of an intersection through deep learning or the like and recognition based on previously given conditions (presence of a signal, a road sign, or the like for which pattern matching is possible) in parallel and evaluating both comprehensively through scoring. This guarantees the reliability of automated driving.

The recognizer 130 recognizes states such as the position, speed and acceleration of each object present near the own vehicle M on the basis of information input from the camera 10, the radar device 12, and the finder 14 via the object recognition device 16. The position of the object is recognized, for example, as a position in an absolute coordinate system whose origin is at a representative point on the own vehicle M (such as the center of gravity or the center of a drive shaft thereof), and used for control. The position of the object may be represented by a representative point on the object such as the center of gravity or a corner thereof or may be represented by an expressed region. The “states” of the object may include an acceleration or jerk of the object or a “behavior state” thereof (for example, whether or not the object is changing or is going to change lanes).

The recognizer 130 recognizes, for example, a lane in which the own vehicle M is traveling (a travel lane). For example, the recognizer 130 recognizes the travel lane, for example, by comparing a pattern of road lane lines (for example, an arrangement of solid and broken lines) obtained from the second map information 62 with a pattern of road lane lines near the own vehicle M recognized from an image captured by the camera 10. The recognizer 130 may recognize the travel lane by recognizing travel boundaries (road boundaries) including road lane lines, road shoulders, curbs, a median strip, guardrails, or the like, without being limited to road lane lines. This recognition may be performed taking into consideration a position of the own vehicle M acquired from the navigation device 50 or a result of processing by the INS. The recognizer 130 recognizes temporary stop lines, obstacles, red lights, toll gates, and other road phenomena.

When recognizing the travel lane, the recognizer 130 recognizes the position or attitude of the own vehicle M with respect to the travel lane. For example, the recognizer 130 may recognize both a deviation from the lane center of the reference point of the own vehicle M and an angle formed by the travel direction of the own vehicle M relative to an extension line of the lane center as the relative position and attitude of the own vehicle M with respect to the travel lane. Alternatively, the recognizer 130 may recognize the position of the reference point of the own vehicle M with respect to one of the sides of the travel lane (a road lane line or a road boundary) or the like as the relative position of the own vehicle M with respect to the travel lane.

The recognizer 130 recognizes an object present in the passenger compartment of the own vehicle M on the basis of the image captured by the vehicle interior camera 70. For example, the function of “recognizing an object present in the passenger compartment” is realized by recognizing an object by deep learning or the like. The recognizer 130 recognizes, on the basis of a sound detected by the microphone, the generation position of a knocking sound due to the rider knocking on the own vehicle M, the rhythm of the knocking sound, the number of knocks heard in the knocking sound within a predetermined time, and the like. The recognizer 130 recognizes an operation of stroking the own vehicle M detected by the touch panel.

The recognizer 130 includes a parking space recognizer 132 that is activated in a self-propelled parking event that will be described later. Details of the functions of the parking space recognizer 132 will be described later.

The behavior plan generator 140 generates a target trajectory along which the own vehicle M will travel in the future automatically (independently of the driver's operation), basically such that the own vehicle M travels in the recommended lane determined by the recommended lane determiner 61 and copes with situations occurring near the own vehicle M. The target trajectory includes, for example, a speed element. The target trajectory is expressed, for example, by an arrangement of points (trajectory points) which are to be reached by the own vehicle M in order. The trajectory points are points to be reached by the own vehicle M at intervals of a predetermined travel distance (for example, at intervals of about several meters) along the road. Apart from this, a target speed and a target acceleration for each predetermined sampling time (for example, every several tenths of a second) are determined as a part of the target trajectory. The trajectory points may be respective positions at the predetermined sampling times which the own vehicle M is to reach at the corresponding sampling times. In this case, information on the target speed or the target acceleration is represented with the interval between the trajectory points.

When generating the target trajectory, the behavior plan generator 140 may set an automated driving event. Examples of the automated driving event include a constant-speed travel event, a low-speed following travel event, a lane change event, a branching event, a merging event, a takeover event, and a self-propelled parking event that is an event of performing parking by unmanned driving in valet parking or the like. The behavior plan generator 140 generates a target trajectory according to an activated event. The behavior plan generator 140 includes a self-propelled parking controller 142 that is activated when a self-propelled parking event is performed. Details of the functions of the self-propelled parking controller 142 will be described later.

The second controller 160 controls the travel driving force output device 200, the brake device 210, and the steering device 220 such that the own vehicle M passes through the target trajectory generated by the behavior plan generator 140 at scheduled times.

Returning to FIG. 2, the second controller 160 includes, for example, an acquirer 162, a speed controller 164, and a steering controller 166. The acquirer 162 acquires information on the target trajectory (trajectory points) generated by the behavior plan generator 140 and stores it in a memory (not shown). The speed controller 164 controls the travel driving force output device 200 or the brake device 210 on the basis of a speed element pertaining to the target trajectory stored in the memory. The steering controller 166 controls the steering device 220 according to the degree of bending of the target trajectory stored in the memory. The processing of the speed controller 164 and the steering controller 166 is realized, for example, by a combination of feedforward control and feedback control. As an example, the steering controller 166 performs the processing by combining feedforward control according to the curvature of the road ahead of the own vehicle M and feedback control based on deviation from the target trajectory. A combination of the behavior plan generator 140 and the second controller 160 is an example of the “driving controller.”

The travel driving force output device 200 outputs a travel driving force (torque) required for the vehicle to travel to driving wheels. The travel driving force output device 200 includes, for example, a combination of an internal combustion engine, an electric motor, a transmission, and the like and an electronic control unit (ECU) that controls them. The ECU controls the above constituent elements according to information input from the second controller 160 or information input from the driving operators 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor according to information input from the second controller 160 or information input from the driving operators 80 such that a brake torque corresponding to a braking operation is output to each wheel. The brake device 210 may include, as a backup, a mechanism for transferring a hydraulic pressure generated by an operation of the brake pedal included in the driving operators 80 to the cylinder via a master cylinder. The brake device 210 is not limited to that configured as described above and may be an electronically controlled hydraulic brake device that controls an actuator according to information input from the second controller 160 and transmits the hydraulic pressure of the master cylinder to the cylinder.

The steering device 220 includes, for example, a steering ECU and an electric motor. The electric motor, for example, applies a force to a rack-and-pinion mechanism to change the direction of steering wheels. The steering ECU drives the electric motor according to information input from the second controller 160 or information input from the driving operators 80 to change the direction of the steering wheels.

### [Self-Propelled Parking Event—at the Time of Vehicle Storage]

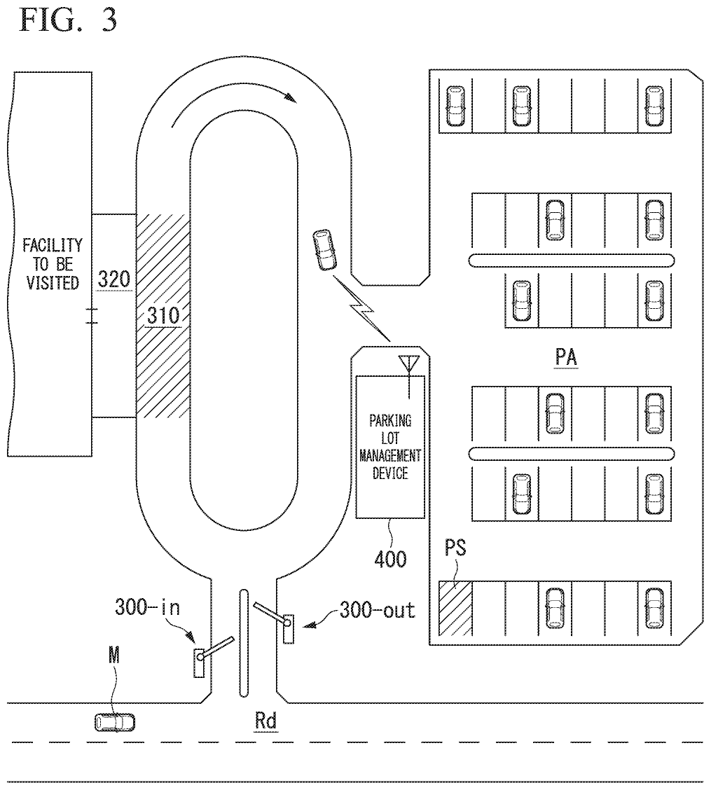

The self-propelled parking controller 142 causes the own vehicle M to be parked in a parking space, for example, on the basis of information that has been acquired from the parking lot management device 400 through the communication device 20. FIG. 3 is a diagram schematically showing a scene in which a self-propelled parking event is performed. Gates 300-in and 300-out are provided on a route from a road Rd to a facility to be visited and a route from the facility to be visited to the road Rd, respectively. The own vehicle M advances to a stop area 310 through the gate 300-in by manual driving or automated driving. The stop area 310 faces an alighting/boarding area 320 connected to the facility to be visited. An eave for blocking rain and snow is provided in the alighting/boarding area 320.

After letting the rider alight in the stop area 310, the own vehicle M starts a self-propelled parking event of performing automated driving to move to a parking space PS in the parking lot PA. Details of a start trigger of the self-propelled parking event relating to vehicle storage will be described later. Upon starting the self-propelled parking event, the self-propelled parking controller 142 transmits a parking request to the parking lot management device 400 by controlling the communication device 20. Then, the own vehicle M moves from the stop area 310 to the parking lot PA while following guidance of the parking lot management device 400 or performing detecting by itself.

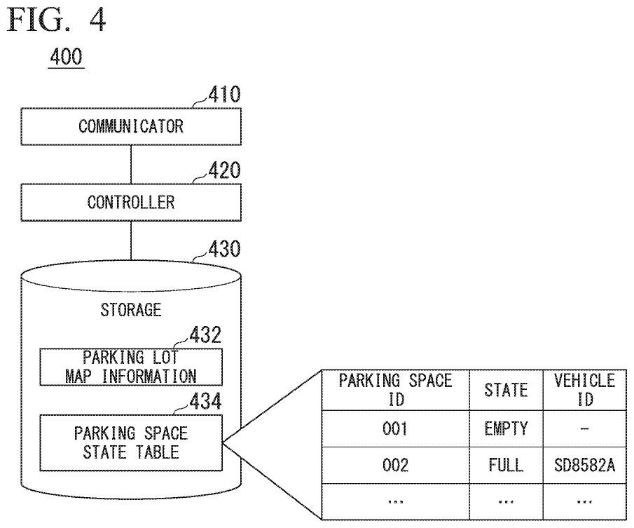

FIG. 4 is a diagram showing an example of the configuration of the parking lot management device 400. The parking lot management device 400 includes, for example, a communicator 410, a controller 420, and a storage 430. The storage 430 stores information such as parking lot map information 432 and a parking space state table 434.

The communicator 410 wirelessly communicates with the own vehicle M and other vehicles. The controller 420 guides the vehicle to the parking space PS on the basis of the information acquired by the communicator 410 and the information stored in storage 430. The parking lot map information 432 is information geometrically representing the structure of the parking lot PA. The parking lot map information 432 includes coordinates of each parking space PS. The parking space state table 434 is, for example, a table in which a state indicating whether a parking space is empty or full (occupied) and a vehicle ID that is identification information of a vehicle parked in the parking space if the parking space is full are associated with each parking space ID that is identification information of the parking space PS.

When the communicator 410 has received a parking request from a vehicle, the controller 420 refers to the parking space state table 434 to extract an empty parking space PS, acquires the position of the extracted parking space PS from the parking lot map information 432, and transmits a suitable route to the acquired position of the parking space PS to the vehicle using the communicator 410. Based on the positional relationships of a plurality of vehicles, the controller 420 instructs a specific vehicle to stop, slow down or the like as necessary such that vehicles do not proceed to the same position at the same time.

In the vehicle that has received the route (hereinafter assumed to be an own vehicle M), the self-propelled parking controller 142 generates a target trajectory based on the route. When approaching the target parking space PS, the parking space recognizer 132 recognizes a parking frame line or the like defining the parking space PS to recognize a detailed position of the parking space PS and provides the recognized detailed position of the parking space PS to the self-propelled parking controller 142. Upon receiving this, the self-propelled parking controller 142 corrects the target trajectory and causes the own vehicle M to be parked in the parking space PS.

### [Self-Propelled Parking Event—at the Time of Vehicle Retrieval]

The self-propelled parking controller 142 and the communication device 20 remain in operation while the own vehicle M is parked. The self-propelled parking controller 142 activates the system of the own vehicle M to move the own vehicle M to the stop area 310, for example, when the communication device 20 has received a pick-up request from the terminal device TM of the rider. At this time, the self-propelled parking controller 142 transmits a start request to the parking lot management device 400 by controlling the communication device 20. Based on the positional relationships of a plurality of vehicles, the controller 420 of the parking lot management device 400 instructs a specific vehicle to stop, slow down or the like as necessary such that vehicles do not proceed to the same position at the same time, similar to the case of vehicle storage. When the own vehicle M is caused to move to the stop area 310 and the rider boards the own vehicle M, the self-propelled parking controller 142 stops operating. Thereafter, manual driving or automated driving based on another functional unit is started.

The self-propelled parking controller 142 is not limited to the above description but may find an empty parking space by itself on the basis of detection results of the camera 10, the radar device 12, the finder 14, or the object recognition device 16 without depending on communication and cause the own vehicle M to be parked in the found parking space.

### [Start Trigger of Self-Propelled Parking Event Relating to Vehicle Storage]

A start trigger of the self-propelled parking event relating to vehicle storage may be, for example, an operation performed by the rider or may be a predetermined signal wirelessly received from the parking lot management device 400. The following description will refer to the case where the start trigger of the self-propelled parking event relating to vehicle storage is (1) a gesture of the rider with respect to the own vehicle M or (2) knocking of the rider on the own vehicle M.

[(1) Gesture of Rider with Respect to Own Vehicle M]

When the self-propelled parking event relating to vehicle storage is started, the own vehicle M is stopped in the stop area 310 and the rider alights the own vehicle M in the alighting/boarding area 320. For example, when the rider has alighted, the recognizer 130 recognizes a movement of a body of the rider such as a hand, the head or the torso (hereinafter referred to as a gesture) on the basis of an image showing surroundings of the own vehicle M that the camera 10 has captured after all doors of the own vehicle M are closed. “When the rider has alighted” means a predetermined time (for example, several tens of seconds to several minutes) after the rider alights the own vehicle M and closes the doors of the own vehicle M or a period until the rider is a predetermined distance (for example, several meters to several tens of meters) or more from the own vehicle M after alighting the own vehicle M. The recognizer 130 starts a self-propelled parking event relating to vehicle storage on the basis of the recognized gesture and the specific gesture information 182. The specific gesture information 182 is information in which information indicating a gesture of a rider and a command executed in the own vehicle M (a command to start a self-propelled parking event relating to vehicle storage in this example) are associated with each other. The gesture of the rider is, for example, a body movement such as waving a hand at the vehicle or indicating a travel direction of the own vehicle M with a hand or a finger. The following description will refer to the case where the specific gesture information 182 is information in which a “command to start a self-propelled parking event relating to vehicle storage” and a “gesture of waving a hand” are associated with each other. The gesture of the rider with respect to the own vehicle M is an example of a “specific operation that the rider performs toward the body of the vehicle.”

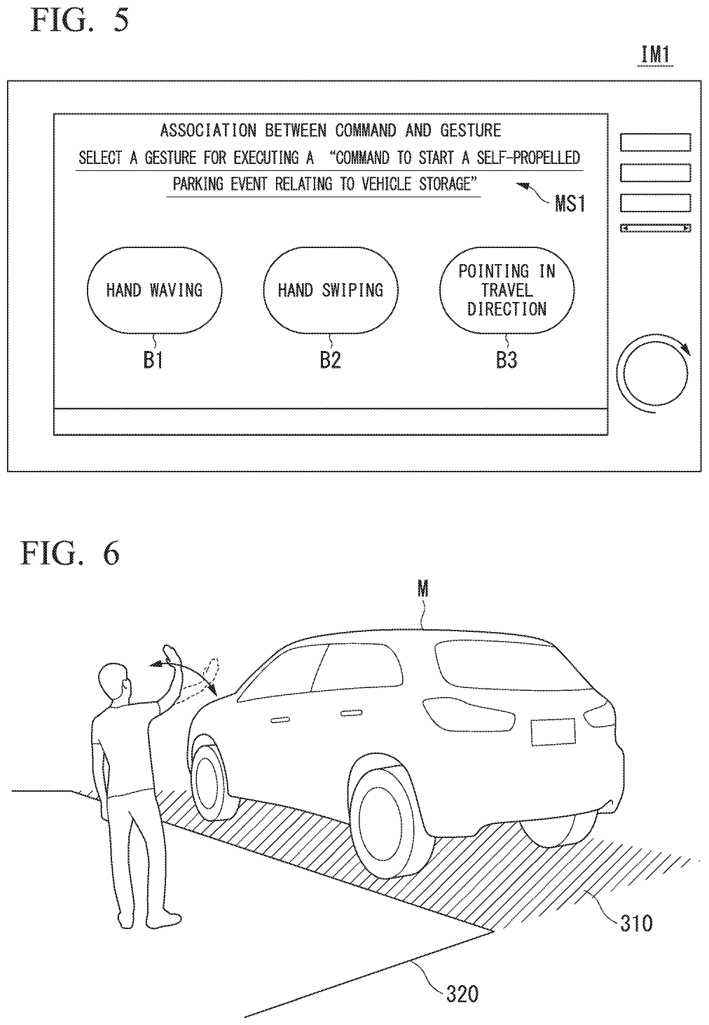

The specific gesture information 182 is, for example, information in which a plurality of gestures recognizable by the recognizer 130 are associated with commands that can be executed according to the gestures. The specific gesture information 182 may be generated by the rider of the own vehicle M associating a gesture with a command A command that can be executed according to a gesture is, for example, a command that can be executed even when the rider of the own vehicle M is not in the own vehicle M. FIG. 5 is a diagram showing an example of an execution screen IM1 of an application for generating the specific gesture information 182. When generating the specific gesture information 182, the automated driving control device 100 executes the application for generating the specific gesture information 182 and causes the HMI 30 to display the execution screen IM1. The execution screen IM1 includes a message MS1 asking the rider of the own vehicle M which gesture is to be associated with a command and buttons B1 to B3 for selecting a gesture that can be associated with the command (that is, a gesture that can be recognized by the recognizer 130). The message MS1 has, for example, content such as “Select a gesture for executing a ‘command to start a self-propelled parking event relating to vehicle storage.’” A gesture that can be associated with this command is, for example, “waving a hand” or “pointing in the travel direction.” The rider of the own vehicle M selects a gesture on the basis of the execution screen IM1 displayed on the HMI 30 and the automated driving control device 100 associates the gesture selected by the rider with the command to generate the specific gesture information 182.

The process of generating the specific gesture information 182 may be performed in the terminal device TM of the rider of the own vehicle M. In this case, the automated driving control device 100 receives the specific gesture information 182 generated by the terminal device TM of the rider via the network and stores the received specific gesture information 182 in the storage 180.

FIG. 6 is a diagram showing an example of a scene in which a self-propelled parking event relating to vehicle storage is started by a gesture. In FIG. 6, the rider performs a gesture of waving his or her hand at the own vehicle M after alighting the own vehicle M in the alighting/boarding area 320. The recognizer 130 recognizes that the rider is performing a gesture of waving his or her hand at the own vehicle M on the basis of an image of surroundings of the own vehicle M captured by the camera 10. The recognizer 130 searches the specific gesture information 182 using content of the recognized gesture and specifies a command “to start a self-propelled parking event relating to vehicle storage” associated with the “gesture of waving a hand at the own vehicle M.” The self-propelled parking controller 142 performs a self-propelled parking event relating to vehicle storage when the recognizer 130 has recognized the command “to start a self-propelled parking event relating to vehicle storage.”

### [(2) Knocking of Rider on Own Vehicle M]

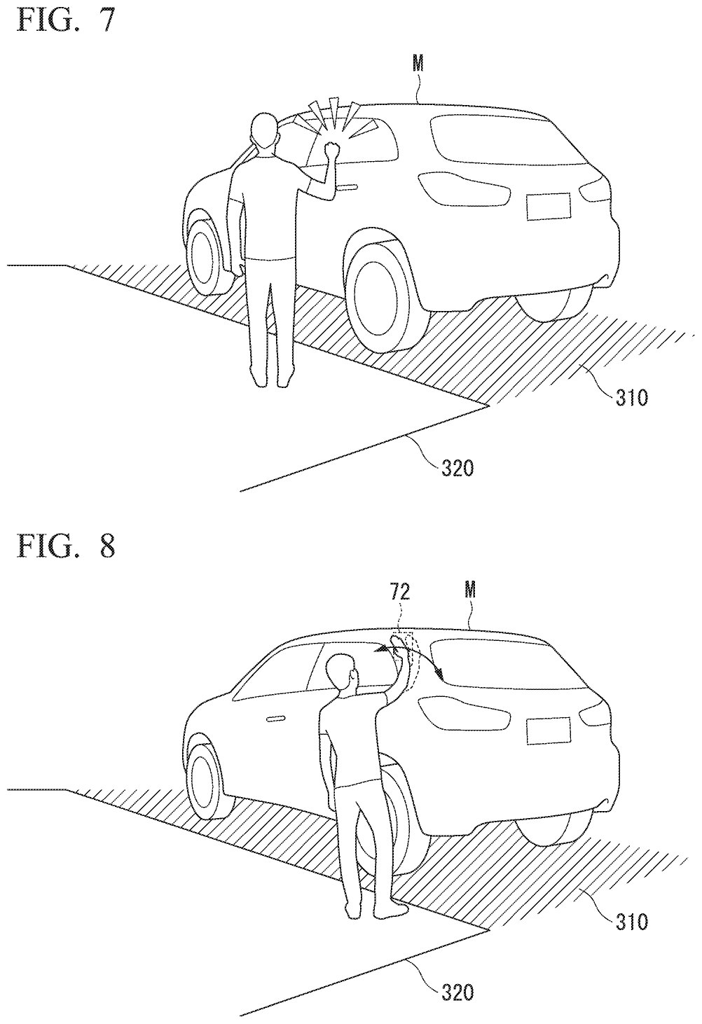

FIG. 7 is a diagram showing an example of a scene in which a self-propelled parking event relating to vehicle storage is started by knocking.

When the self-propelled parking event relating to vehicle storage is started, the own vehicle M is stopped in the stop area 310 and the rider alights the own vehicle M in the alighting/boarding area 320. For example, when the rider has alighted, the recognizer 130 recognizes knocking of the rider on the basis of a sound that the specific contact operation detection device 72 (the microphone) has detected after all doors of the own vehicle M are closed. The recognizer 130 starts a self-propelled parking event relating to vehicle storage on the basis of the recognized knocking and the specific contact operation information 184. The specific contact operation information 184 includes, for example, information including a record in which information indicating knocking of the rider and a command executed in the own vehicle M (a command to start a self-propelled parking event relating to vehicle storage in this example) are associated with each other. The information indicating knocking of the rider is, for example, information indicating a predetermined rhythm or a predetermined number of knocks. The following description will refer to the case where the specific contact operation information 184 is information including a record in which a command to start a self-propelled parking event relating to vehicle storage and two consecutive knocks are associated with each other. Knocking of the rider on the own vehicle M is an example of a “specific operation that the rider performs on the body of the vehicle.”

The command that can be executed according to knocking is, for example, a command that can be executed even when the rider of the own vehicle M is not in the own vehicle M. When generating the specific contact operation information 184, the automated driving control device 100 executes an application for generating the specific contact operation information 184.

Subsequent processing is the same as that when the specific gesture information 182 is generated and therefore description thereof will be omitted.

In FIG. 7, the rider performs two consecutive knocks on the own vehicle M after alighting the own vehicle M in the alighting/boarding area 320. The recognizer 130 recognizes that the rider has performed two consecutive knocks on the basis of a sound detected by the specific contact operation detection device 72. The recognizer 130 searches the specific contact operation information 184 using content of the recognized knocking and specifies a command “to start a self-propelled parking event relating to vehicle storage” associated with “two consecutive knocks.” The self-propelled parking controller 142 performs a self-propelled parking event relating to vehicle storage when the recognizer 130 has recognized the command “to start a self-propelled parking event relating to vehicle storage.”

### [(3) Stroking Operation of Rider on Own Vehicle M]

FIG. 8 is a diagram showing an example of a scene in which a self-propelled parking event relating to vehicle storage is started by a stroking operation. When the self-propelled parking event relating to vehicle storage is started, the own vehicle M is stopped in the stop area 310 and the rider alights the own vehicle M in the alighting/boarding area 320. For example, when the rider has alighted, the recognizer 130 recognizes a stroking operation of the rider on the basis of a detection result of the specific contact operation detection device 72 (the touch panel) after all doors of the own vehicle M are closed. The recognizer 130 starts a self-propelled parking event relating to vehicle storage on the basis of the recognized stroking operation and the specific contact operation information 184. The specific contact operation information 184 includes, for example, information including a record in which information indicating a stroking operation of the rider and a command executed in the own vehicle M (a command to start a self-propelled parking event relating to vehicle storage in this example) are associated with each other. The following description will refer to the case where the specific contact operation information 184 is information including a record in which a command to start a self-propelled parking event relating to vehicle storage and a stroking operation are associated with each other. A stroking operation of the rider on the own vehicle M is an example of a “specific operation that the rider performs on the body of the vehicle.”

The command that can be executed according to a stroking operation is, for example, a command that can be executed even when the rider of the own vehicle M is not in the own vehicle M. When generating the specific contact operation information 184, the automated driving control device 100 executes an application for generating the specific contact operation information 184. Subsequent processing is the same as that when the specific gesture information 182 is generated and therefore description thereof will be omitted.

In FIG. 8, the rider performs a stroking operation on the own vehicle M after alighting the own vehicle M in the alighting/boarding area 320. The recognizer 130 recognizes that the rider has performed a stroking operation on the basis of a detection result of the specific contact operation detection device 72. The recognizer 130 searches the specific contact operation information 184 using content of the recognized stroking operation and specifies a command “to start a self-propelled parking event relating to vehicle storage” associated with the “stroking operation.” The self-propelled parking controller 142 performs a self-propelled parking event relating to vehicle storage when the recognizer 130 has recognized the command “to start a self-propelled parking event relating to vehicle storage.”

### [Conditions for Stopping Self-Propelled Parking Event Relating to Vehicle Storage]

Here, even when an instruction to start a self-propelled parking event relating to vehicle storage has been issued, the self-propelled parking controller 142 does not perform the self-propelled parking event (cancels start of the self-propelled parking event or stops the self-propelled parking event even after the event is started) if a predetermined condition indicating that automatic parking is inappropriate is satisfied.

The predetermined condition under which the self-propelled parking controller 142 stops the self-propelled parking event is that at least one of the following conditions is satisfied.
(1) It has been recognized that the terminal device TM of the rider is left behind in the passenger compartment of the own vehicle M.
(2) A travelable distance based on the remaining energy of the own vehicle M is equal to or less than a reference.
(3) A failure of a detection device whose result is referred to by the recognizer 130 has been detected.
(4) It has been recognized that a person is present in the passenger compartment of the own vehicle M.
   [(1) when it has been Recognized that the Terminal Device TM of the Rider is Left Behind in the Passenger Compartment of the Own Vehicle M]

The recognizer 130 extracts a difference between two images, for example, on the basis of a past image of the passenger compartment captured by the vehicle interior camera 70 and an image of the passenger compartment captured when the rider has alighted. The past image of the passenger compartment is, for example, an image captured in a state where no rider is in the own vehicle M and no luggage is loaded in the own vehicle M. Feature data (including a compressed image) of the past image of the passenger compartment or an image extracted for comparison is stored in the storage 180. When a difference has been extracted between the two images or their characteristic data, the recognizer 130 recognizes an object present at a location where the difference has occurred. The self-propelled parking controller 142 does not perform a self-propelled parking event relating to vehicle storage when the recognition result of the recognizer 130 indicates that the object present at the location where the difference has occurred is the terminal device TM of the rider of the own vehicle M.

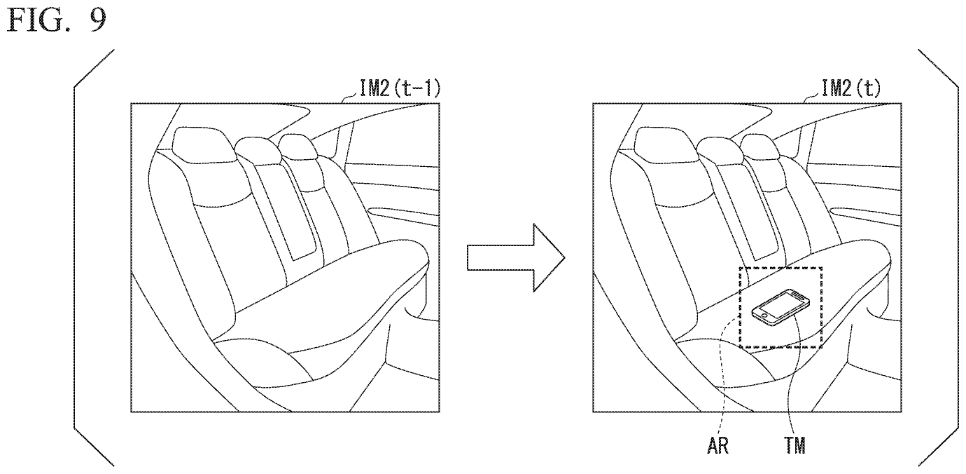

FIG. 9 is a diagram showing an example of an image (IM2(t)) of the passenger compartment captured by the vehicle interior camera 70 and an image (IM2(t−1)) of the passenger compartment captured in the past. The recognizer 130 extracts a difference between the image (IM2(t)) of the passenger compartment captured when the rider has alighted and the past image (IM2(t−1)). In FIG. 9, the recognizer 130 extracts a difference that has occurred at the position of an area AR in the image (IM2(t)) of the passenger compartment. The recognizer 130 recognizes an object present at the position of the area AR in the image (IM2(t)) of the passenger compartment. When the recognition result of the recognizer 130 indicates that the object present at the position of the area AR is the terminal device TM, the self-propelled parking controller 142 does not perform the self-propelled parking event relating to vehicle storage.

When the rider of the own vehicle M retrieves the own vehicle M from the parking lot PA through a self-propelled parking event relating to vehicle retrieval, the rider transmits a pick-up request using the terminal device TM. However, the rider may not be able to transmit a pick-up request when the terminal device TM was left behind in the passenger compartment of the own vehicle M at the time of vehicle storage thereof. When the terminal device TM is left behind in the passenger compartment of the own vehicle M, the self-propelled parking controller 142 can prompt the rider to carry the terminal device TM without performing the self-propelled parking event relating to vehicle storage.

The above description refers to the case where the recognizer 130 recognizes that the terminal device TM is left behind in the own vehicle M on the basis of an image of the passenger compartment captured by the vehicle interior camera 70. However, the present invention is not limited to this. For example, the recognizer 130 may recognize that the terminal device TM is left behind in the own vehicle M when a change in the weight of the own vehicle M (hereinafter referred to as a vehicle weight) has been recognized on the basis of a detection result of a detector that detects the vehicle weight. When the terminal device TM has a communication function using a non-contact chip such as that of radio frequency identifier (RFID) authentication, the recognizer 130 may recognize that the terminal device TM is left behind in the own vehicle M if communication between the terminal device TM and the automated driving control device 100 is being performed using the communication function even after the rider alights the own vehicle M.

When the recognizer 130 has recognized that the terminal device TM is left behind in the own vehicle M, the automated driving control device 100 may control in-vehicle equipment of the own vehicle M to notify the rider that the terminal device TM is left behind. For example, the automated driving control device 100 may control a headlight, a turn signal, and the like to notify the rider by light, control an audio mounted in the own vehicle M to notify the rider by sound, control a wiper driver to notify the rider by movement of wipers, or control the travel driving force output device 200 such that the own vehicle M moves (for example, makes a vibrating or wiggling, back and forth movement) to notify the rider by the movement.

[(2): When the Travelable Distance Based on the Remaining Energy of the Own Vehicle M is Equal to or Less than a Reference]

The self-propelled parking controller 142 calculates a travelable distance of the own vehicle M, for example, on the basis of a remaining battery capacity detected by the remaining battery level detector 74 and information indicating power consumption of the own vehicle M. The self-propelled parking controller 142 also calculates a travelable distance of the own vehicle M on the basis of a remaining amount of fuel detected by the remaining fuel detector 76 and information indicating fuel consumption of the own vehicle M. The self-propelled parking controller 142 does not perform the self-propelled parking event relating to vehicle storage when the total sum of the calculated travelable distances is equal to or less than a reference. The reference is, for example, a distance obtained by summing the distances of a route from the stop area 310 to the parking lot PA, a route for traveling to a parking space PS in the parking lot PA, and a route from the parking space PS to the stop area 310. Thereby, the self-propelled parking controller 142 can curb the own vehicle M from stopping in the middle of storage in the parking lot PA or retrieval from the parking lot PA.

When the own vehicle M includes only the internal combustion engine as a driving source, the own vehicle M may not include the remaining battery level detector 74. When the own vehicle M includes only the electric motor as a driving source, the own vehicle M may not include the remaining fuel detector 76. In this case, the self-propelled parking controller 142 may determine whether or not to perform the self-propelled parking event relating to vehicle storage on the basis of only the travelable distance calculated based on the detection result of the remaining battery level detector 74 or only the travelable distance calculated based on the detection result of the remaining fuel detector 76 and the reference. In the following description, the remaining capacity of the battery and the remaining amount of fuel will be referred to as “remaining energy” when they are not distinguished from each other.

### [(3): When a Failure of a Detection Device Whose Result is Referred to by the Recognizer 130 is Detected]

The self-propelled parking controller 142 does not perform the self-propelled parking event relating to vehicle storage, for example, when the failure detection device 18 has detected a failure of a detection device. As described above, the recognizer 130 recognizes states of an object present near the own vehicle M such as the position, speed, and acceleration thereof on the basis of information input from the camera 10, the radar device 12, and the finder 14 via the object recognition device 16. Therefore, when a detection device has failed, the self-propelled parking controller 142 cannot cause the own vehicle M to be parked in a parking space PS through a self-propelled parking event. Since the self-propelled parking controller 142 does not perform a self-propelled parking event relating to vehicle storage when the failure detection device 18 has detected a failure of a detection device, the self-propelled parking controller 142 can perform a self-propelled parking event relating to vehicle storage only when the own vehicle M can be safely parked in the parking lot PA by automated driving.

[(4): when it has been Recognized that a Person is Present in the Passenger Compartment of the Own Vehicle M]

The recognizer 130 extracts a difference between two images, for example, on the basis of a past image of the passenger compartment captured by the vehicle interior camera 70 and an image of the passenger compartment captured when the rider has alighted. When a difference has been extracted between the two images, the recognizer 130 recognizes an object present at a location where the difference has occurred. The self-propelled parking controller 142 does not perform a self-propelled parking event relating to vehicle storage when the recognition result of the recognizer 130 indicates that the object present at the location where the difference has occurred is a person.

Here, when a plurality of riders board the own vehicle M and some of the riders are infants or elderly persons, an infant or an elderly person may be left behind in the own vehicle M after the other riders alight in the alighting/boarding area 320. When it is difficult for the rider left behind to alight by himself (that is, when the rider left behind is an infant or an elderly person), parking of the own vehicle M in the parking lot PA through a self-propelled parking event may harm the health of the rider. The self-propelled parking controller 142 does not perform a self-propelled parking event relating to vehicle storage when a rider is left behind in the own vehicle M, thus ensuring the safety of the rider. The above processing allows a rider who has already alighted the own vehicle M to recognize that the self-propelled parking event has not been performed (stopped) and to notice the rider left behind in the own vehicle M. Stopping of the self-propelled parking event may be clearly indicated to the rider who has already alighted the own vehicle M not only by the own vehicle M having not started the self-propelled parking event (the parking operation) but also, for example, by not blinking of a blinking light body that should blink when a self-propelled parking event is started or by a physical movement such as not folding of mirrors of the own vehicle M.

### [Operation Flow]

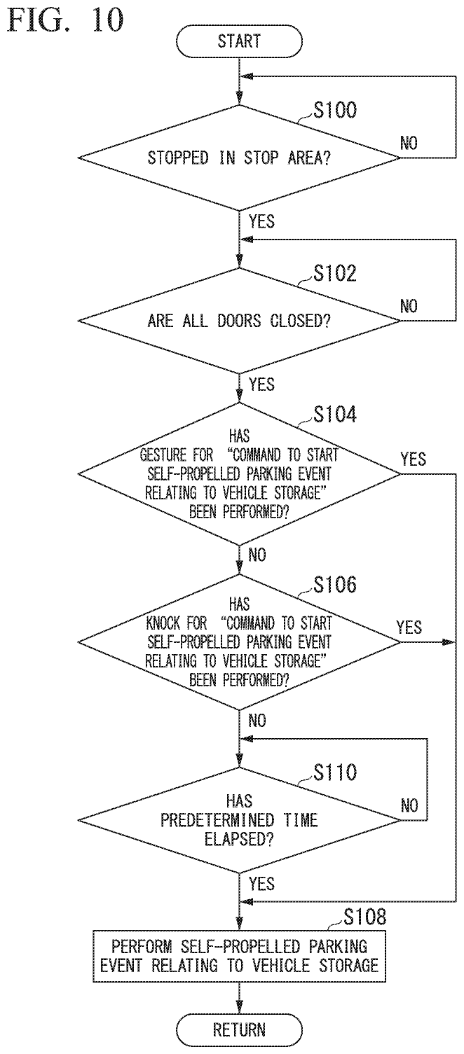

FIG. 10 is a flowchart showing a flow of a series of processes for starting a self-propelled parking event relating to vehicle storage. First, the self-propelled parking controller 142 determines whether or not a recognition result of the recognizer 130 indicates that the own vehicle M is stopped in the stop area 310 (step S100).

The self-propelled parking controller 142 waits until a recognition result of the recognizer 130 indicates that the own vehicle M is stopped in the stop area 310. When the recognizer 130 has recognized that the own vehicle M is stopped in the stop area 310, the self-propelled parking controller 142 determines whether or not a recognition result of the recognizer 130 indicates that all doors of the own vehicle M are closed (step S102).

The self-propelled parking controller 142 waits until all doors of the own vehicle M are closed.

After all doors of the own vehicle M stopped in the stop area 310 are closed, the self-propelled parking controller 142 determines whether or not the recognizer 130 has recognized that a rider who has alighted the own vehicle M has performed a gesture associated with a “command to start a self-propelled parking event relating to vehicle storage” (step S104). When the recognizer 130 has recognized that the rider who has alighted the own vehicle M has performed the gesture associated with the “command to start a self-propelled parking event relating to vehicle storage,” the self-propelled parking controller 142 performs the self-propelled parking event relating to vehicle storage (step S108).

When the recognizer 130 has not recognized that the gesture has been performed, the self-propelled parking controller 142 determines whether or not the recognizer 130 has recognized that a rider who has alighted the own vehicle M has performed knocking associated with the “command to start a self-propelled parking event relating to vehicle storage” (step S106). When the recognizer 130 has recognized that the rider who has alighted the own vehicle M has performed the knocking associated with the “command to start a self-propelled parking event relating to vehicle storage,” the self-propelled parking controller 142 performs the self-propelled parking event relating to vehicle storage (step S108).

When the recognizer 130 has recognized none of the gesture and the knock, the self-propelled parking controller 142 determines whether or not a predetermined time has elapsed after all doors of the own vehicle M stopped in the stop area 310 are closed (step S110). The self-propelled parking controller 142 waits until the predetermined time elapses after all doors of the own vehicle M stopped in the stop area 310 are closed. The self-propelled parking controller 142 performs a self-propelled parking event relating to vehicle storage upon determining that the predetermined time has elapsed after all doors of the own vehicle M stopped in the stop area 310 are closed (step S108).

When the recognizer 130 has recognized neither the gesture nor the knock, the self-propelled parking controller 142 may not perform the self-propelled parking event relating to vehicle storage. In this case, the process of step S110 is omitted.

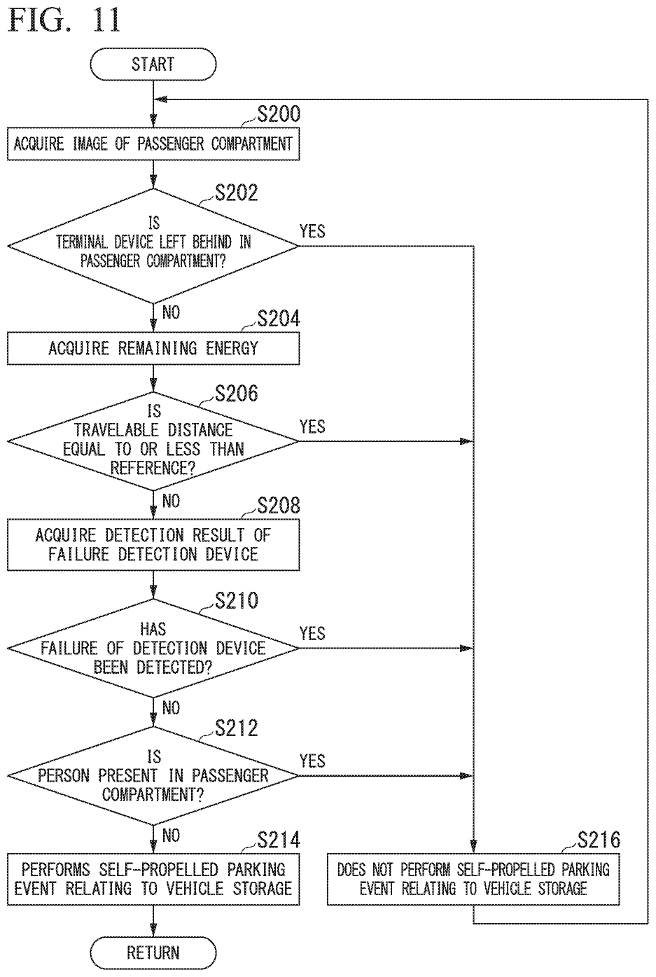

FIG. 11 is a flowchart showing a flow of a series of processes for stopping a self-propelled parking event relating to vehicle storage. The flowchart shown in FIG. 11 shows processing that the self-propelled parking controller 142 performs during execution of a self-propelled parking event relating to vehicle storage. First, the recognizer 130 obtains an image of the passenger compartment captured by the specific contact operation detection device 72 (step S200).

The self-propelled parking controller 142 determines whether or not a recognition result of the recognizer 130 indicates that the terminal device TM is left behind in the passenger compartment (step S202). When the self-propelled parking controller 142 has determined that the terminal device TM is left behind in the passenger compartment, the process proceeds to step S216.

Next, the self-propelled parking controller 142 obtains, for example, at least one of a remaining battery capacity detected by the remaining battery level detector 74 and a remaining amount of fuel detected by the remaining fuel detector 76 (step S204). The self-propelled parking controller 142 determines whether or not a travelable distance of the own vehicle M calculated based on the acquired remaining battery capacity, information indicating power consumption of the own vehicle M, the acquired remaining amount of fuel, and information indicating fuel consumption of the own vehicle M is equal to or less than a reference (step S206). When the travelable distance of the own vehicle M is equal to or less than the reference, the self-propelled parking controller 142 advances the process to step S216.

When the travelable distance of the own vehicle M is greater than the reference, the self-propelled parking controller 142 acquires a detection result of the failure detection device 18 (step S208). The self-propelled parking controller 142 determines whether or not the failure detection device 18 has detected a failure of a detection device (step S210).

When the failure detection device 18 has detected a failure of a detection device, the self-propelled parking controller 142 advances the process to step S216.

When the failure detection device 18 has detected no failures of detection devices, the self-propelled parking controller 142 determines whether or not a recognition result of the recognizer 130 indicates that a person is present in the passenger compartment (step S212). When a recognition result of the recognizer 130 indicates that a person is present in the passenger compartment, the self-propelled parking controller 142 advances the process to step S216.

The self-propelled parking controller 142 performs a self-propelled parking event relating to vehicle storage (step S214) when none of the condition that it has been recognized that the terminal device TM of the rider is left behind in the passenger compartment of the own vehicle M (condition 1), the condition that a travelable distance based on the remaining energy of the own vehicle M is equal to or less than a reference (condition 2), the condition that a failure of a detection device whose result is referred to by the recognizer 130 has been detected (condition 3), and the condition that it has been recognized that a person is present in the passenger compartment of the own vehicle M (condition 4) is satisfied.

The self-propelled parking controller 142 does not perform a self-propelled parking event relating to vehicle storage (step S216) when any of the condition that it has been recognized that the terminal device TM of the rider is left behind in the passenger compartment of the own vehicle M (condition 1), the condition that a travelable distance based on the remaining energy of the own vehicle M is equal to or less than a reference (condition 2), the condition that a failure of a detection device whose result is referred to by the recognizer 130 has been detected (condition 3), and the condition that it has been recognized that a person is present in the passenger compartment of the own vehicle M (condition 4) is satisfied. After step S216, the self-propelled parking controller 142 returns to step S200 to determine again whether or not the conditions 1 to 4 are satisfied and performs a self-propelled parking event relating to vehicle storage (step S214) when none of the conditions 1 to 4 is satisfied.

### Summary of Embodiment

As described above, the automated driving control device 100 according to the present embodiment includes the recognizer 130 that recognizes a surrounding environment of the own vehicle M and a driving controller (the behavior plan generator 140 and the second controller 160 in this example) that automatically performs speed control and steering control of the own vehicle M on the basis of the recognition result of the recognizer 130, wherein the self-propelled parking controller 142 causes, after letting a rider alight the own vehicle M, the own vehicle M to travel and be parked in a parking lot (the parking lot PA) when the recognizer 130 has recognized a specific operation that the alighted rider has performed on or toward the body of the vehicle, whereby it is possible to improve convenience. The recognizer 130 may perform any one of gesture recognition and knocking recognition and may change the recognition target and the priority of recognition on the basis of the weather. For example, based on the weather, the recognizer 130 preferentially recognizes a gesture instead of knocking when it rains since the body of the vehicle gets wet in the rain and preferentially recognizes knocking instead of a gesture when there is fog since it is difficult to recognize a gesture on the basis of an image in the fog.

The automated driving control device 100 according to the present embodiment includes the recognizer 130 that recognizes a surrounding situation of the own vehicle M and a driving controller (the behavior plan generator 140 and the second controller 160 in this example) that automatically performs speed control and steering control of the own vehicle M on the basis of the recognition result of the recognizer 130, and a determiner (the self-propelled parking controller 142 in this example) that determines whether or not a predetermined condition indicating that automatic parking is inappropriate is satisfied when a rider has alighted the own vehicle M, wherein the self-propelled parking controller 142 causes, upon determining that the predetermined condition is not satisfied, the own vehicle M to start traveling from a stopped state and then be parked in the parking lot and does not cause, upon determining that the predetermined condition is satisfied, the own vehicle M to travel and then be parked in the parking lot (the parking lot PA), whereby it is possible to curb the occurrence of inconvenience due to careless automatic control of the own vehicle M with surroundings of the own vehicle M not being monitored by the rider. In automatic parking assist with the user (a rider or a candidate rider) having a duty to monitor the surroundings, the user watches parking of the own vehicle M until it is completed. On the other hand, in automatic parking with the user having no duty to monitor the surroundings, the user does not watch parking of the own vehicle M until it is completed. Therefore, after automatic parking starts, it is difficult to cope with abnormality even if the user notices the abnormality. Thus, by not starting automatic parking on the basis of satisfaction of the predetermined condition before automatic parking starts, it is possible to curb the occurrence of inconvenience.

### [Hardware Configuration]

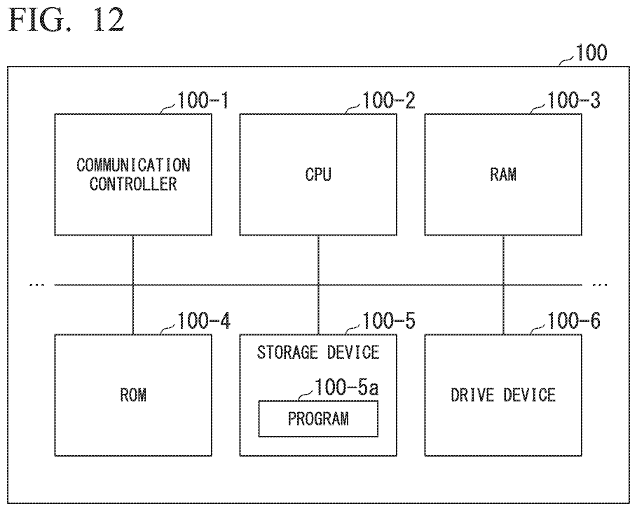

FIG. 12 is a diagram showing an example of the hardware configuration of the automated driving control device 100 according to an embodiment. As shown, the automated driving control device 100 is configured such that a communication controller 100-1, a CPU 100-2, a random access memory (RAM) 100-3 used as a working memory, a read only memory (ROM) 100-4 storing a boot program or the like, a storage device 100-5 such as a flash memory or a hard disk drive (HDD), a drive device 100-6, or the like are connected to each other via an internal bus or a dedicated communication line. The communication controller 100-1 performs communication with components other than the automated driving control device 100. The storage device 100-5 stores a program 100-5a to be executed by the CPU 100-2. This program is loaded in the RAM 100-3 by a direct memory access (DMA) controller (not shown) or the like and then executed by the CPU 100-2. Thereby, some or all of the recognizer 130, the behavior plan generator 140, and the self-propelled parking controller 142 are realized.

The embodiments described above can be expressed as follows.

An automated driving control device including: a storage device configured to store a program; and a hardware processor, wherein the hardware processor is configured to execute the program stored in the storage device to: recognize a surrounding situation of a vehicle; automatically perform speed control and steering control of the vehicle on the basis of a result of the recognition; determine whether or not a predetermined condition indicating that automatic parking is inappropriate is satisfied when a user has alighted the vehicle; cause, upon determining that the predetermined condition is not satisfied, the vehicle to start traveling from a stopped state and then be parked in a parking lot with surroundings of the vehicle not being monitored by the user or a person other than the user; and does not cause, upon determining that the predetermined condition is satisfied, the vehicle to start traveling from a stopped state and then be parked in a parking lot with surroundings of the vehicle not being monitored by the user or a person other than the user.

The embodiments described above can also be expressed as follows.

An automated driving control device including: a storage device configured to store a program; and a hardware processor, wherein the hardware processor is configured to execute the program stored in the storage device to: recognize a surrounding environment of a vehicle; automatically perform speed control and steering control of the vehicle on the basis of a result of the recognition; and cause, after letting a user alight the vehicle, the vehicle to start traveling from a stopped state upon recognizing a specific operation that the alighted user performs on or toward a body of the vehicle.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control system comprising:
a recognizer configured to recognize a surrounding environment of a vehicle; and
a driving controller configured to automatically perform speed control and steering control of the vehicle on the basis of a recognition result of the recognizer,
wherein the driving controller is configured to cause, after letting a user alight the vehicle, the vehicle to start traveling from a stopped state when the recognizer has recognized a specific operation that the alighted user performs on or toward a body of the vehicle.

2. The vehicle control system according to claim 1, wherein the specific operation includes a gesture of the alighted user.

3. The vehicle control system according to claim 1, wherein the specific operation includes knocking on the body of the vehicle.

4. The vehicle control system according to claim 3, wherein the driving controller is configured to cause the vehicle to start traveling from a stopped state when the recognizer has recognized that the knocking has a predetermined rhythm or that the knocking includes a predetermined number of knocks.

5. The vehicle control system according to claim 3, wherein the recognizer is configured to recognize the knocking detected by a sound detector configured to detect a sound in a passenger compartment of the vehicle.

6. The vehicle control system according to claim 1, wherein the specific operation includes a stroking operation of the alighted user.

7. The vehicle control system according to claim 6, wherein the recognizer is configured to recognize the stroking operation detected by a contact detector configured to detect touching of a person on the body of the vehicle.

8. A vehicle control method comprising:
a computer recognizing a surrounding environment of a vehicle;
automatically performing speed control and steering control of the vehicle on the basis of a result of the recognition; and
causing, after letting a user alight the vehicle, the vehicle to start traveling from a stopped state upon recognizing a specific operation that the alighted user performs on or toward a body of the vehicle.

9. A non-transitory computer-readable storage medium storing a program that causes a computer to:
recognize a surrounding environment of a vehicle;
automatically perform speed control and steering control of the vehicle on the basis of a result of the recognition; and
cause, after letting a user alight the vehicle, the vehicle to start traveling from a stopped state upon recognizing a specific operation that the alighted user performs on or toward a body of the vehicle.
